(19) United States
(12) Patent Application Publication
(10) Pub. No.: US 2026/0260897 A1
(43) Pub. Date: Sep. 3, 2026

(54) BATTERY ELECTRODE AND METHOD OF MAKING THE SAME

(71) Applicant: SPECIALTY OPERATIONS FRANCE, Lyon (FR)

(72) Inventors: Stefano Mauri, Giussano (IT); Riccardo Rino Pieri, Milano (IT); Maurizio Biso, Milano (IT); David James Wilson, LA POMAREDE (FR); Wojciech Bzducha, Lyon (FR); Jean-Raoul Gomez, Boulogne -Billancourt (FR)

(73) Assignee: SPECIALTY OPERATIONS FRANCE, Lyon (FR)

(21) Appl. No.: 19/109,112

(22) PCT Filed: Sep. 4, 2023
(86) PCT No.: PCT/EP2023/074114

§ 371 Date: Mar. 5, 2025

(30) Foreign Application Priority Data
Sep. 8, 2022 (EP) 22306333.0

(51) Int. Cl. H01M 4/62; C08F 220/56; C08J 3/20; C08J 5/18; C08K 3/02; C08K 3/04; C08K 3/32; C08L 27/18; C08L 33/26; H01M 4/04; H01M 4/131; H01M 4/58

(52) U.S. Cl. CPC H01M 4/628; C08F 220/56; C08J 3/203; C08J 5/18; C08K 3/04; C08K 3/32; C08L 27/18; C08L 33/26; H01M 4/0404; H01M 4/131; H01M 4/5825; H01M 4/623; C08F 2800/10; C08J 2327/18; C08J 2333/26; C08K 2003/023; C08K 2003/328; C08K 2201/001

(57) ABSTRACT

The present invention relates to an electrode powdery composition, to a method for its preparation and to its use for the manufacture of electrochemical cell components.

### CROSS REFERENCE TO PREVIOUS APPLICATIONS

This application claims priority to European application No. 22306333.0 filed on 8 September April 2022, the whole content of this application being incorporated herein by reference for all purposes.

### TECHNICAL FIELD

The present invention relates to an electrode powdery composition, to a method for its preparation and to its use for the manufacture of electrochemical cell components.

### BACKGROUND ART

To date, the electrodes of a lithium secondary battery are mainly manufactured by a wet process that comprises preparing a slurry in which an electrode active material, additives and a binder are dispersed in a solvent or an aqueous medium, and processing the slurry in a way that forms an electrode film.

Dry electrode processes have been developed to reduce the time-consuming and costly drying procedures required by the aforementioned wet processes.

Typical dry processes use the fibrillation properties of certain polymers to provide a matrix for embedded conductive material. Some of the polymers in the family of fluoropolymers, such as polytetrafluoroethylene (PTFE), are particularly inert and stable in the common electrolyte solvents used in secondary batteries, even those using organic solvent at high working or storage temperatures. Thus, the stability of an electrode made using PTFE can be higher than those made with other binders.

For example, dry electrode preparation processes can include combining a PTFE binder with active electrode material in powder form, and calendering to form an electrode film. However, although PTFE has good adhesiveness to the electrode active material, it has difficulty in adhesiveness to the current collector.

Another drawback of PTFE is related to its limited electrochemical stability at anode side that could result in polymer degradation and in lower coulombic efficiency when used as binder for anodes.

Moreover, when the anode is made of silicon, one of the key obstacles to overcome is the significant volume change that occurs in silicon active materials when they absorb (expand) and desorb (contract) lithium during charge-discharge cycles. These substantial shrink-swell cycles impart high mechanical stress on the anode layer causing fractures and contact loss in the circuit that leads to reduced capacity and eventual failure of the electrochemical cell.

To overcome the specific challenges associated with silicon, one approach is to create a self-healing mechanism within the binder matrix by incorporating weak bonding interactions that enable a degree of reversibility, where these labile bonds can be disrupted under stress but reformed upon relaxation without irreparable damage to the active material particles. Unfortunately PTFE is not able to intimately interact with the active materials through such bonding interactions and is not a good candidate binder for silicon rich anode.

There are many approaches being pursued to develop next generation binders to accommodate silicon anodes.

There are multiple polycarboxylate binders and derivatives being pursued, including polyacrylic acids, polyamic acids, polyacrylamides, and other hydrogen bonding structures.

The Applicant has unexpectedly found that certain polymers obtained by copolymerization of at least one monomer bearing a carboxylic group and at least one monomer bearing an acrylamide may be used in the dry electrode preparation processes, especially for the preparation of silicon-rich anodes, thus providing electrodes by a very efficient process.

### SUMMARY OF INVENTION

In one aspect, the present invention thus provides a process for manufacturing an electrode [electrode (E)] for electrochemical cell, said process comprising, preferably consisting of, the following steps:
i) providing a polymer (P) that comprises:
   (A) recurring units derived from at least one α,β-ethylenically unsaturated carboxylic acid monomer [monomer (AA)]; and
   (B) recurring units derived from at least one (meth)acrylamide monomer [monomer (AM)] of formula (I):

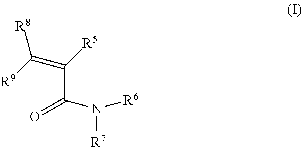

wherein
R⁵ represents a hydrogen atom or a methyl group, R⁶ and R⁷, being the same or different from each other, may be selected from a hydrogen atom or from a linear or branched alkyl group having 1 to 6 carbon atoms, R⁸ and R⁹, being the same or different from each other, may be selected from the group consisting of a hydrogen atom, from a linear or branched alkyl group having 1 to 6 carbon atoms, a carboxylic group and an amide group;
(C) optionally, recurring units derived from at least one monomer (M) selected from the group consisting of a monomer (M1) and a monomer (M2),
   wherein
   monomer (M1) is an ethylenically unsaturated monomer carrying an unsaturated heterocyclic group having at least one nitrogen atom, said monomer (M1) having the formula (II) below:

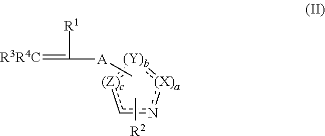

wherein:
R¹ is H or an alkyl group, wherein the alkyl group is preferably a methyl group;
R² is H or an alkyl group;
R³ and R⁴, being the same or different from each other, may be selected from a hydrogen atom or from a linear or branched alkyl group having 1 to 6 carbon atoms;
A is a linkage selected from the group consisting of:
   a single covalent bond; and
   a spacer;
wherein X, Y and Z, independently from each other, are selected from a carbon atom or a nitrogen atom;
wherein a, b and c are, independently from each other, selected from the integer 1 to 2;
wherein each dashed-dotted line represents an optional double bond;
monomer (M2), different from monomer (AA) and from monomer (AM), said monomer (M2) having the formula (III) below:

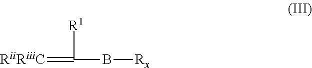

wherein:
Rⁱ is selected from the group consisting of H, —COOH, —CH₂COOH or an alkyl group, wherein the alkyl group is preferably a methyl group;
Rⁱⁱ and Rⁱⁱⁱ being the same or different from each other, may be selected from a hydrogen atom or from a linear or branched alkyl group having 1 to 6 carbon atoms, or can be —COOH group;
B is a linkage selected from the group consisting of a —C(O)—O— group and a —C(O)—NH— group;
Rₓ is selected from a hydrogen atom or a linear or branched C₃-C₂₀ hydrocarbon chain moiety comprising at least one functional groups selected from the group consisting of ether (—O—), heterocyclic group, sulfonic acid group (—SO₃H), salt of sulfonic acid group (—SO₃Cat), phosphonic acid group (—PO₃H₂), salt of phosphonic acid group (—PO₃Cat₂), phosphoric acid group (—OPO₃H₂), and salt of a phosphoric acid group (—OPO₃Cat₂), with Cat being a monovalent cation preferably selected from alkali metals cations, more preferably is selected from Na⁺, K⁺ and Li⁺;
ii) dry mixing at least one electrode active material (AM), the polymer (P) provided in step i) as above defined, and optionally, at least one conductive agent in the absence of solvent to provide a dry electrode forming composition [composition (C)];
iii) feeding the composition (C) obtained in step ii) to a compactor to form a self-supporting dry film; and
iv) applying the dry film to an electrically conductive substrate to form the electrode.

In another aspect, the present invention provides an electrode (E) for a secondary battery obtainable by the process as above defined.

The polymer (P) could be conveniently used as the only binder or in blend with PTFE granting high adhesion even at moderate processing temperature (about 100° C.).

In another aspect the present invention thus provides a process for manufacturing an electrode [electrode (E1)] for electrochemical cell, said process comprising:
step I) combining a polytetrafluoroethylene (PTFE) and a polymer (P) as above defined to provide a binder (B);
step II) dry mixing the at least one electrode active material (AM), the binder (B) as above defined, and optionally, at least one conductive agent in the absence of solvent to provide a dry electrode forming composition [composition (C1)];
step III) feeding the composition (C1) obtained in step II) to a compactor to form a self-supporting dry film; and
step IV) applying the dry film to an electrically conductive substrate to form the electrode.

In another aspect, the present invention provides an electrode (E1) for a secondary battery obtainable by the process as above defined.

In a further aspect, the present invention relates to an electrochemical device, such as a secondary battery or a capacitor, comprising at least one electrode (E) or electrode (E1) as defined above.

### DESCRIPTION OF EMBODIMENTS

In the context of the present invention, the term “weight percent” (wt %) indicates the content of a specific component in a mixture, calculated as the ratio between the weight of the component and the total weight of the mixture. When referred to the recurring units derived from a certain monomer in a polymer/copolymer, weight percent (wt %) indicates the ratio between the weight of the recurring units of such monomer over the total weight of the polymer/copolymer. When referred to the total solid content of a liquid composition, weight percent (wt %) indicates the ratio between the weight of all non-volatile ingredients in the liquid.

As used herein, the terms “adheres” and “adhesion” indicate that two layers are permanently attached to each other via their surfaces of contact.

By the term “electrochemical device”, it is hereby intended to denote an electrochemical cell/assembly comprising a positive electrode, a negative electrode and a liquid electrolyte, wherein a monolayer or multilayer separator is in contact to at least one surface of one of the said electrodes. Non-limitative examples of suitable electrochemical devices include, notably, secondary batteries, especially, alkaline or an alkaline-earth secondary batteries such as lithium ion batteries, lead-acid batteries, and capacitors, especially lithium ion-based capacitors and electric double layer capacitors (supercapacitors). Non-limitative examples of electrochemical cells include, notably, batteries, preferably secondary batteries, and electric double layer capacitors.

For the purpose of the present invention, by “secondary battery” it is intended to denote a rechargeable battery. Non-limitative examples of secondary batteries include, notably, alkaline or alkaline-earth secondary batteries.

### The Polymer (P)

In step i) of the process of the present invention, a polymer (P) is provided, wherein polymer (P) can be obtained by radical copolymerization of a mixture of at least one e α,β-ethylenically unsaturated carboxylic acid monomer (AA) and at least one (meth)acrylamide monomer [monomer (AM)] as above defined.

The at least one α,β-ethylenically unsaturated carboxylic acid monomer (AA) is preferably a compound of formula (IV):

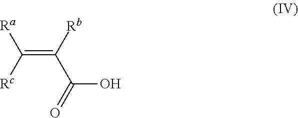

wherein R^{a}, R^{b} and R^{c}, equal to or different from each other, are independently selected from a hydrogen atom and a C₁-C₃ hydrocarbon group.

More preferably, monomer (AA) is a compound of formula (IV) as above defined, that is selected from the group consisting of acrylic acid, methacrylic acid, Sipomer BCEA (sold by Solvay), ethacrylic acid, crotonic, methyl (meth)acrylic acid, ethyl (meth)acrylic acid, propyl (meth)acrylic acid, isopropyl (meth)acrylic acid, n-butyl (meth)acrylic acid, 2-ethylhexyl (meth)acrylic acid, n-hexyl (meth)acrylic acid and n-octyl (meth)acrylic acid.

The (meth)acrylamide monomer [monomer (AM)] of formula (II) is preferably selected from the group consisting of (meth)acrylamides or N-substituted (meth)acrylamide such as N-alkyl acrylamides, N,N-dialkylacrylamides.

According to an embodiment of the present invention, polymer (P) comprises at least one monomer (M1), which is an ethylenically unsaturated monomer carrying an unsaturated heterocyclic group having at least one nitrogen atom as above defined.

The “unsaturated heterocyclic group having at least one nitrogen atom” in monomer (M1) of formula (II) includes preferably a 5- to 6-membered aromatic cyclic group having at least one N in the ring and, such as:

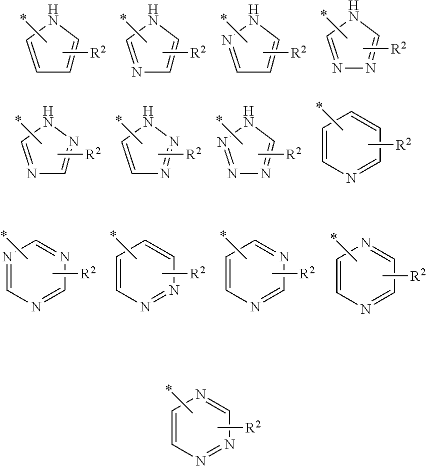

wherein * represent the tie point of the linkage A.

The linkage A and the residue R² may be attached to the heterocyclic group at any position, either on carbon or nitrogen atom.

The monomer (M1) may for example be:
vinylimidazole (Vim) of formula (IIa):

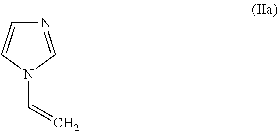

2-methyl-1-vinylimidazole of formula (IIb)

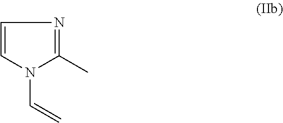

1-vinyl-1,2,4-triazole of formula (IIc)

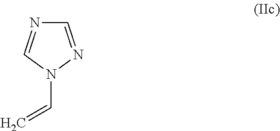

2-vinylpyrazine of formula (IId)

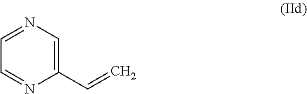

4-vinylpyridine of formula (IIe)

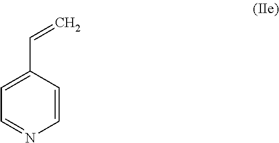

2-vinylpyridine of formula (IIf)

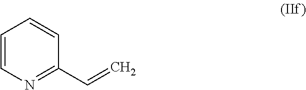

hydroxyl-(meth)acrylate imidazole derivative of formula (IIg)

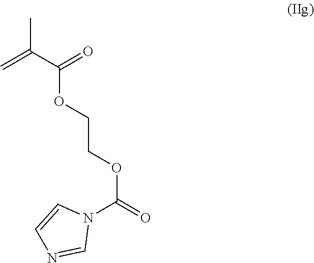 [SMILES: C=C(C)C(=O)OCCOC(=O)n1ccnc1]

The divalent spacer group A in formula (II) may typically be group —CO—NH—(CH₂)ₙ—, —CO—O—(CH₂)ₙ or —CO—O—(CH₂)ₙ—O—CO—, but any other covalent linker group may be contemplated, for example resulting from the reaction of a compound of formula (II-X):

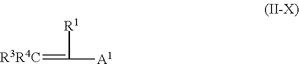

wherein R⁶, R⁸ and R⁹ are as above defined, with a compound of formula (II-Y):

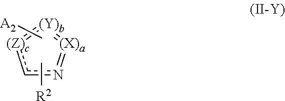

wherein R² is as above defined, A¹ and A² are two groups reacting together for forming a covalent bond.

For example, A² may be a —(CH₂)ₘ—NH₂ group wherein m is from 1 to 4, preferably 2 or 3. In that case, A¹ may be for example a carboxylic acid, an acid chloride, an anhydride or an epoxy.

According to another variant, A² may be a —(CH₂)ₘ—OH group wherein m is from 1 to 4, preferably 2 or 3. In that case, A¹ may be for example a carboxylic acid, an acid chloride, an anhydride or an ester.

According to this embodiment, the polymer (P) is a polymer as obtained by copolymerizing monomers (AA), (AM) and at least one monomer (M1), namely having the structure that is obtained via such a polymerization, but the polymer (P) is not necessarily obtained by this process. As an alternative, the polymer (P) may for example be obtained by a first step of copolymerizing monomer (AA), monomer (AM) and a compound of formula (II-X) leading to a polymer (P0) and then a second step of post-grafting of the polymer (P0) by a reaction with compound (II-Y).

When A² is a —(CH₂)ₘ—NH₂ group in the compound (II-Y), the compound (II-X) may advantageously be selected from: additional acrylic or methacrylic acid, or ester thereof; maleic anhydride; vinylbenzyl chloride; glycidylmethacrylate; and (blocked) isocyanatoethyl methacrylate.

When A² is a —(CH₂)ₘ—OH group in the compound (II-Y), the compound (II-X) may advantageously be selected from additional acrylic acid, methacrylic acid, maleic anhydride or their esters.

Besides, a quaternization of all or part of the imidazole functions of polymer (P) may occur, resulting from a quaternization of all or part of the monomers and/or form a post-quaternization of all or part of the imidazole functions of the polymer.

According to another embodiment of the present invention, polymer (P) comprises at least one monomer (M2) of formula (III) as above defined.

The “heterocyclic group” in residue Rₓ of monomer (M2) includes saturated heterocyclic group having at least one nitrogen atom compound, such as imidazolidinone.

According to a first variant wherein B in formula (III) is a —C(O)—O— group, the monomer (M2) may for example be a compound of formula (IIIa)

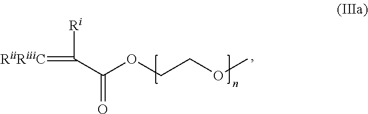

a compound of formula (IIIb)

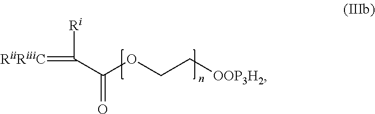

or
a compound of formula (IIIc)

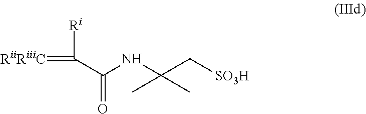

wherein in the formulae (IIIa) to (IIc) Rⁱ, Rⁱⁱ and Rⁱⁱⁱ are as above defined, and n is an integer from 1 to 40.

According to a second variant wherein B in formula (III) is a —C(O)—NH— group, the monomer (M2) may for example be a compound of formula (IIId)

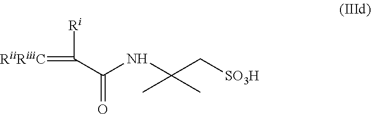

or a compound of formula (IIIe)

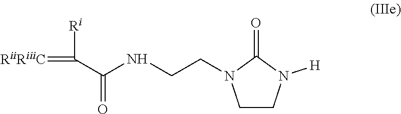

wherein in the formulae (IIId) and (IIIe) Rⁱ, Rⁱⁱ and Rⁱⁱⁱ are as above defined.

According to this embodiment, the polymer (P) is a polymer as obtained by copolymerizing monomers (AA), (AM) and at least one monomer (M2), namely having the structure that is obtained via such a polymerization, but the polymer (P) is not necessarily obtained by this process.

The at least one polymer (P) may further comprise below 10% by moles of one or more further monomers (M′) selected from the group consisting of hydrophobic monomers and amphiphilic monomers provided the total amount of monomer (AA) and/or monomer (AM) is at least 60% by moles with respect to the total moles of recurring units of polymer (P).

In this embodiment where additional monomers (M′) are present in polymer (P), said hydrophobic and/or amphiphilic monomers are selected from the group consisting of monoethylenically unsaturated monomers:
alkyl esters of maleic anhydride and (meth)acrylic acid, such as monomethyl maleic anhydride ester, dimethyl maleic anhydride ester, monoethyl maleic anhydride ester, diethyl maleic anhydride ester, methyl (meth)acrylate, ethyl (meth)acrylate, propyl (meth)acrylate, isopropyl (meth)acrylate, n-butyl (meth)acrylate, 2-ethylhexyl (meth)acrylate, n-hexyl (meth)acrylate, n-octyl (meth)acrylate,
hydroxyalkyl esters of maleic anhydride and (meth)acrylic acid, such as monohydroxyethyl maleic anhydride ester, dihydroxyethyl maleic anhydride ester, hydroxyethyl (meth)acrylate, hydroxypropyl (meth)acrylate, hydroxybutyl (meth)acrylate
ethoxylates and propoxylates that derive from maleic anhydride, such as such as poly(propylene oxide)-b-poly(ethylene oxide) maleic acid half ester or diester alkyl-poly(ethylene oxide) maleic acid half ester or diester,
ethoxylates and/or propoxylates that derive from the ethoxylation and/or propoxylation of hydroxyalkyl (meth)acrylic acid, such as poly(propylene oxide)-b-poly(ethylene oxide)-ethyl (meth)acrylate
ethoxylates and/or propoxylates that derive from the (trans)esterification of (meth)acrylic acid and esters such as poly(propylene oxide)-b-poly(ethylene oxide) (meth)acrylate and alkyl-poly(ethylene oxide) (meth)acrylate
Vinyl ethers such as methyl vinyl ether, ethyl vinyl ether, propyl vinyl ether, 2-ethylhexyl vinyl ether, vinyl cyclohexyl ether, dodecyl vinyl ether, 2-(diethylamino)ethyl vinyl ether, 2-(di-n-butylamino)ethyl vinyl ether allyl ethers such as methyl vinyl ether, ethyl vinyl ether, propyl vinyl ether, 2-ethylhexyl vinyl ether,
Vinyl esters, such as vinyl acetate or vinyl propionate alkyl-substituted acrylamides such as N-tert-butyl acrylamide or N-methyl (meth)acrylamide.

Preferably, additional monomers (M′) that are present in polymer (P) are selected from the group consisting of:
monoethyl maleic anhydride ester, diethyl maleic anhydride ester, methyl (meth)acrylate, ethyl (meth)acrylate, isopropyl (meth)acrylate, n-butyl (meth)acrylate, 2-ethylhexyl (meth)acrylate
monohydroxyethyl maleic anhydride ester, dihydroxyethyl maleic anhydride ester, hydroxyethyl (meth)acrylate, hydroxypropyl (meth)acrylate, hydroxybutyl (meth)acrylate
poly(propylene oxide)-b-poly(ethylene oxide) maleic acid half ester
poly(propylene oxide)-b-poly(ethylene oxide)-ethyl (meth)acrylate
poly(propylene oxide)-b-poly(ethylene oxide) (meth)acrylate, alkyl-poly(ethylene oxide) (meth)acrylate
vinyl acetate, vinyl propionate.

The proportion in moles of monomers (M′) cannot exceed 10% by moles of the total moles of monomers (AA+AM+M+M′) present in polymer (P). Advantageously the proportion in moles of monomers (M′) is below 5% by moles.

The at least one polymer (P) may further comprise below 1% by moles of one or more further crosslinking monomers (XL-M) comprising at least two ethylenic unsaturations.

In this embodiment where additional monomers (XL-M) are present in polymer (P), said crosslinking monomers may be chosen from N,N′-methylenebisacrylamide (MBA), N,N′-ethylenebisacrylamide, polyethylene glycol (PEG) diacrylate, triacrylate, divinyl ether, typically trifunctional divinyl ether, for example tri(ethylene glycol) divinyl ether (TEGDE), N-diallylamines, N,N-diallyl-N-alkylamines, the acid addition salts thereof and the quaternization products thereof, the alkyl used here being preferentially (C₁-C₃)-alkyl; compounds of N,N-diallyl-N-methylamine and of N,N-diallyl-N,N-dimethylammonium, for example the chlorides and bromides; or alternatively ethoxylated trimethylolpropane triacylate, ditrimethylolpropane tetraacrylate (DiTMPTTA), divinylbenzene (DVB), ethoxylated or propoxylated bisphenol A diacrylate, dipropylene glycol diacrylate (DPGDA), tripropylene glycol diacrylate (TPGDA), propoxylated di(meth)acrylate, butyloxylated di(meth)acrylate, dimethylacrylamide, 1, 4-butanediol dimethacrylate (BDDMA), 1,6-hexanediol dimethacrylate (HDDMA), 1,3-butylene glycol dimethacrylate (BGDMA), and derivatives thereof.

The proportion in moles of monomers (XL-M) cannot exceed 1% by moles of the total moles of monomers (AA+AM+M+M′+XL-M) present in polymer (P) to avoid gel formation and viscosity increase. Advantageously the proportion in moles of monomers (M′) is below 0.5% by moles.

According to said embodiment, polymer (P) obtained by a polymerization that further includes monomer (XL-M) is at least partially crosslinked.

In one preferred embodiment of the invention, there are no further monomers (M′) or (XL-M) in the polymer (P).

Typically, the polymer (P) is obtained by radical copolymerization of a mixture of:
at least one monomer (AA),
at least one monomer (AM),
optionally at least one monomer (M),
optionally at least one monomer (M′) and,
optionally at least one monomer (XL-M),
in the presence of a source of free radicals.

Any source of free radicals can be used. It is possible in particular to generate free radicals spontaneously, for example by increasing the temperature, with appropriate monomers, such as styrene. It is possible to generate free radicals by irradiation, in particular by UV irradiation, preferably in the presence of appropriate UV-sensitive initiators. It is possible to use initiators or initiator systems of radical or redox type. The source of free radicals may or may not be water-soluble. It may be preferable to use water-soluble initiators or at least partially water-soluble initiators.

Generally, the greater the amount of free radicals, the more easily the polymerization is initiated (it is promoted) but the lower the molar masses of the copolymers obtained. Use may in particular be made of the following initiators:
peroxides, such as: hydrogen peroxides, tert-butyl hydroperoxide, cumene hydroperoxide, tbutyl
peroxyacetate, t-butyl peroxybenzoate, t-butyl peroxyoctoate, t-butyl peroxyneodecanoate, t-butyl peroxyisobutyrate, lauroyl peroxide, t-amyl peroxypivalate, tbutyl peroxypivalate, dicumyl peroxide, benzoyl peroxide, sodium persulfate, potassium persulfate or ammonium persulfate,
azo compounds, such as: 2,2′-azobisisobutyronitrile, 2,2′-azobis(2-butanenitrile), 4,4′-azobis(4-pentanoic acid), 1,1′-azobis(cyclohexanecarbonitrile), 2-(t-butylazo)-2-cyanopropane, 2,2′-azobis{2-methyl-N-[1,1-bis(hydroxymethyl)-2-hydroxyethyl]propionamide}, 2,2′-azobis[2-methyl-N-(hydroxyethyl)propionamide], 2,2′-azobis(N,N′-dimethyleneisobutyramidine) dihydrochloride, 2,2′-azobis(2-amidinopropane) dihydrochloride, 2,2′-azobis(N,N′-dimethyleneisobutyramide), 2,2′-azobis{2-methyl-N-[1,1-bis(hydroxymethyl)-2-hydroxyethyl]propionamide}, 2,2′-azobis{2-methyl-N-[1,1-bis(hydroxymethyl)ethyl]propionamide}, 2,2′-azobis[2-methyl-N-(2-hydroxyethyl)propionamide] or 2,2′-azobis(isobutyramide) dihydrate,
redox systems comprising combinations, such as: mixtures of hydrogen peroxide, alkyl peroxide, peresters, percarbonates, persulfates and the like and of any iron salt, titanous salt, zinc formaldehydesulfoxylate or sodium formaldehydesulfoxylate, and reducing sugars,
alkali metal or ammonium persulfates, perborates or perchlorates, in combination with an alkali metal bisulfite, such as sodium metabisulfite, and reducing sugars, and
alkali metal persulfates in combination with an arylphosphinic acid, such as benzenephosphonic acid and others of a like nature, and reducing sugars.

The polymerization temperature can in particular be between 25° C. and 95° C. The temperature can depend on the source of free radicals. If it is not a source of UV initiator type, it will be preferable to operate between 50° C. and 95° C., more preferably between 60° C. and 80° C. Generally, the higher the temperature, the more easily the polymerization is initiated (it is promoted) but the lower the molar masses of the copolymers obtained.

According to a preferred embodiment of the present invention, a polymer (P) is obtained by radical polymerization of one monomer (AA), one monomer (AM), and one monomer (M1) in the presence of a source of free radicals, in order to obtain a polymer comprising recurring units derived from monomer (AA) recurring units derived from monomer (AM) and recurring units derived from monomer (M1).

According to a more preferred embodiment, a polymer (P) is obtained by radical polymerization of an acrylic acid, an acrylamide and vinylimidazole of formula (IIa).

Polymer (P) can also be prepared by any controlled radical polymerization technique. Among these, reversible addition-fragmentation chain transfer (RAFT) and macromolecular design via inter-exchange of xanthate (MADIX) can be mentioned.

The use of RAFT or MADIX controlled radical polymerization agents, hereinafter referred to as “RAFT/MADIX agents”, has been disclosed for instance WO 98/058974 A (RHODIA CHIMIE) 30 Dec. 1998 and WO 98/01478 A (E.I. DUPONT DE NEMOURS AND COMMONWEALTH SCIENTIFIC AND INDUSTRIAL RESEARCH ORGANIZATION) 15 Jan. 1998.

Preferably, the polymer (P) is obtained by radical copolymerization of a mixture having the following molar ratio, based on the total quantity of monomer (AA), monomer (AM) and an additional monomer (M), selected from a monomer (M1) and a monomer (M2):
monomer (AA): from 0.1 to 95%, notably from 5 to 50%, preferably from 20 to 40%,
monomer (AM): from 0.1 to 90%, preferably from 25 to 90%, more preferably from 60 to 80%,
monomer (M): from 0.1 to 50%, for example from 1 to 30%, notably from 1 to 20% and even 2 to 15%.

As a consequence, polymer (P) preferably comprises:
from 0.1 to 95%, preferably from 5 to 50%, more preferably from 20 to 40% of recurring units derived from monomer (AA),
from 0.1 to 90%, preferably from 25 to 90%, more preferably from 50 to 80% of recurring units derived from monomer (AM), and
from 1 to 50%, preferably from 1 to 30%, more preferably from 1 to 20% and even 2 to 15% of recurring units derived from monomer (M), all the aforementioned % by moles being referred to the total moles of recurring units of the polymer (P).

In a preferred embodiment of the present invention, polymer (P) comprises:
from 5 to 50%, preferably from 20 to 40% of recurring units derived from monomer (AA),
from 25 to 90%, more preferably from 50 to 80% of recurring units derived from monomer (AM), and
from 1 to 50%, for example from 1 to 30%, notably from 1 to 20% and even 2 to 15% of recurring units derived from monomer (M), all the aforementioned % by moles being referred to the total moles of recurring units of the polymer (P).

Generally, the preparation of polymer (P) can be carried out in a thermally isolated reactor, to minimize the heat exchange with surrounding.

The polymer (P) may also be prepared by other means known to those skilled in the art such as employing a double jacketed reactor equipped with an overhead mechanical stirrer and a thermostatic bath to control the reaction temperature to the desired profile.

Monomers and other reagents may be charged into the reactor at once, ao they may be fed into the reactor with the aid of a suitable dosing device in order to control the polymerisation kinetics.

Besides, the polymer (P) according to the invention preferably has a number average molecular weight (Mn) of at least 90 kDa, for example between 90 and 5000 kDa, preferably from 850 kDa to 2000 kDa.

According to a preferred embodiment, polymer (P) is a statistical (random) copolymer having a weight average molecular weight of about 100 kDa to 10000 kDa, preferably from 1000 kDa to 3000 kDa, which is obtained by radical polymerization of a mixture of monomer (AA), monomer (AM), and a monomer (M), preferably in a molar ratio of about:
from 20 to 40% of monomer (AA),
from 50 to 80% of monomer (AM), and
from 2 to 15% of monomer (M).

According to an embodiment of the invention, polymer (P) is a block copolymer obtained by controlled radical polymerization using RAFT/MADIX agents.

By “block copolymer” as used herein it is intended any controlled-architecture copolymer, including but not limited to true block polymers, which could be di-blocks, tri-blocks, or multi-blocks; branched block copolymers, also known as linear star polymers; comb; and gradient polymers. Gradient polymers are linear polymers whose composition changes gradually along the polymer chains, potentially ranging from a random to a block-like structure. Each block of the block copolymers may itself be a homopolymer, a random copolymer, a random terpolymer, or a gradient polymer.

Polymer (P) can be provided in solid or dry form or in a vectorized form, for example in the form of a solution or of an emulsion or of a suspension, in particular in the form of an aqueous solution. The vectorized form, for example an aqueous solution, can in particular comprise from 3 to 50% by weight of the polymer (P), for example from 5 to 30% by weight. The aqueous solution comprising polymer (P) can in particular be a solution obtained by an aqueous phase preparation process at the end of a radical polymerization process.

Polymer (P) may suitably be converted into its neutralized form polymer (P—N), thus comprising the recurring units derived from the monomer (AA) in a neutralized form.

Polymer (P—N) can be prepared by neutralizing the acid groups of the recurring units derived from monomer (AA) as above defined, wherein the neutralization of acid groups is carried out either with a salt [salt (S)] including a monovalent cation, preferably an alkaline metal salt, in a suitable solvent, or with ammonia.

The salt (S) can be any salt capable of neutralizing the acid groups. In some embodiments, the salt (S) is a lithium salt selected from the group consisting of lithium carbonate, lithium hydroxide, lithium bicarbonate, and combinations thereof, preferably lithium carbonate. In some embodiments, the lithium salt is free of lithium hydroxide.

The solvent for use in the step of neutralization of polymer (P—H) can be any solvent capable of dissolving the salt (S) or ammonia and the resulting polymer (P). Preferably, the solvent is selected from at least one of an aqueous solvent, such as water, NMP, and alcohols, such as, for example, methanol, isopropanol, and ethanol. Most preferably, the solvent is an aqueous solvent. Still more preferably the solvent is water.

Preferably the content of the salt (S) in the solvent ranges from 0.5 to 10 wt %, preferably from 1 to 5 wt %, based on the total weight of the solvent and the salt (S).

In some embodiments wherein the salt (S) is a lithium salt, the concentration of the lithium salt in the solvent provides at least 0.25 eq, 0.5 eq, 0.8 eq, 1 eq, 1.5 eq, 2 eq, 2.5 eq, 3 eq, 4, eq of lithium to acid groups. In some embodiments, the concentration of the lithium salt in the solvent provides at most 5 eq, preferably at most 4, eq of lithium to acid groups.

According to said embodiments, the polymer (P) comprises recurring units derived from the lithiated form of the at least one α,β-ethylenically unsaturated carboxylic acid monomer.

The content of polymer (P) in the solution after neutralization, based on the total weight of the solvent and the polymer (P), ranges from 0.5 to 40 wt %, preferably from 2 to 30 wt %, more preferably 4 to 20 wt %.

The polymer (P—N) is suitably isolated as a solid from the solution after neutralization and optionally stored for later use.

In a preferred embodiment, a lithium salt of polymer (P), namely polymer (P—Li) was prepared by adding an amount of LiOH to at least partially fully neutralize an aqueous solution containing about 10 wt % polymer (P—H). The resulting solution had a pH in the range of 6.5 to 9, preferably in the range of 7 to 8 and contained approximately 10 wt % of polymer (P—Li).

An advantage is that the salified form of the recurring units derived from the monomer (AA) can avoid sequestration of lithium ions by the free acid groups in the cell, which can diminish the first cycle coulombic efficiency and thus the initial capacity.

All the details of the processes of the present invention as defined above and below in relation to the processes comprising the use of the polymer (P) also applies to the processes where (P—N) is used.

### The Electrode Active Material (AM)

For the purpose of the present invention, the term “electrode active material” is intended to denote a compound that is able to incorporate or insert into its structure, and substantially release therefrom, alkaline or alkaline-earth metal ions during the charging phase and the discharging phase of an electrochemical device. The electrode active material is preferably able to incorporate or insert and release lithium ions.

The nature of the electrode active material (AM) depends on whether said composition is used in the manufacture of a negative electrode (anode) or a positive electrode (cathode).

In the case of forming a positive electrode for a Lithium-ion secondary battery, the electrode active material may comprise a composite metal chalcogenide of formula LiMQ₂, wherein M is at least one metal selected from transition metals such as Co, Ni, Fe, Mn, Cr and V and Q is a chalcogen such as O or S. Among these, it is preferred to use a lithium-based composite metal oxide of formula LiMO₂, wherein M is the same as defined above. Preferred examples thereof may include LiCoO₂, LiNiO₂, LiNiₓCo₁₋ₓO₂ (0<x<1) and spinel-structured LiMn₂O₄.

As an alternative, still in the case of forming a positive electrode for a Lithium-ion secondary battery, the electrode active material may comprise a lithiated or partially lithiated transition metal oxyanion-based electro-active material of formula M₁M₂(JO₄)_{f}E_{1-f}, wherein M₁ is lithium, which may be partially substituted by another alkali metal representing less than 20% of the M₁ metals, M₂ is a transition metal at the oxidation level of +2 selected from Fe, Mn, Ni or mixtures thereof, which may be partially substituted by one or more additional metals at oxidation levels between +1 and +5 and representing less than 35% of the M2 metals, including 0, JO₄ is any oxyanion wherein J is either P, S, V, Si, Nb, Mo or a combination thereof, E is a fluoride, hydroxide or chloride anion, f is the molar fraction of the JO₄ oxyanion, generally comprised between 0.75 and 1.

The M₁M₂(JO₄)_{f}E_{1-f} electro-active material as defined above is preferably phosphate-based and may have an ordered or modified olivine structure.

More preferably, the electrode active material in the case of forming a positive electrode has formula Li₃₋ₓM′_{y}M″_{2-y}(JO₄)₃ wherein 0≤x≤3, 0≤y≤2, M′ and M″ are the same or different metals, at least one of which being a transition metal, JO₄ is preferably PO₄ which may be partially substituted with another oxyanion, wherein J is either S, V, Si, Nb, Mo or a combination thereof. Still more preferably, the electrode active material is a phosphate-based electro-active material of formula Li(FeₓMn₁₋ₓ)PO₄ wherein 0≤x≤1 such as lithium iron phosphate (LFP), lithium iron manganese phosphate (LMFP) and lithium manganese phosphate.

As a further alternative, still in the case of forming a positive electrode for a Lithium-ion secondary battery, the electrode active material may comprise garnet-type inorganic particle Li₇La₃Zr₂O₁₂ (LLZO) or doped-LLZO inorganic particle having a general formula of LiₓLa_{y}Zr_{z}A_{w}O₁₂, wherein:
A represents one or several dopants selected from the group consisting of Al, Ga, Nb, Fe, Nd, Pt, Ta, W, Mo, Hf, Si, Ca, Sr, Ba, Ge, and mixtures thereof; preferably from the group consisting of Al, Ga, Nb, Fe, Nd, Pt, Ta, W, and mixtures thereof; more preferably from the group consisting of Al, Ga, W, and mixtures thereof;
w, x, y, and z are positive numbers, including various combinations of integers and fractions or decimals;
0<y≤3; preferably 2≤y≤3; preferably 2.5≤y≤3;
0<z≤2; preferably 1≤z≤2; preferably 1.5≤z≤2;
0≤w≤0.5; preferably 0≤w≤0.35; more preferably 0≤w≤0.25; and
x is derived from electroneutrality of the garnet structure; and
combinations thereof.

In the case of forming a negative electrode for a Lithium-ion secondary battery, the electrode active material may preferably comprise materials selected from the group consisting of one or more carbon-based materials and one or more silicon-based materials.

In some embodiments, the carbon-based materials may be selected from graphite, such as natural or artificial graphite, graphene, or carbon black.

These materials may be used alone or as a mixture of two or more thereof.

The carbon-based material is preferably graphite.

The silicon-based compound may be one or more selected from the group consisting of chlorosilane, alkoxysilane, aminosilane, fluoroalkylsilane, silicon, silicon chloride, silicon carbide and silicon oxide.

More particularly, the silicon-based compound may be silicon oxide or silicon carbide.

The silicon oxide may comprise, in particular, particles with formula SiOₓ with 0.5≤x≤1 that are lithiated material yielding to the formation of Li₄SiO₄ and Li₂SO₃, as disclosed in WO2015/063979.

When present in the electrode active material, the silicon-based compounds are comprised in an amount ranging from 1 to 60% by weight, preferably from 5 to 30% by weight with respect to the total weight of the electro active compounds.

Composition (C) may further comprise one or more optional electroconductivity-imparting additives, which may be added in order to improve the conductivity of a resulting electrode made from the composition (C) of the present invention.

Conducting agents for batteries are known in the art.

Examples thereof may include: carbonaceous materials, such as carbon black, graphite fine powder, carbon nanotubes, graphene, or fiber, or fine powder or fibers of metals such as nickel or aluminum. The optional conductive agent is preferably carbon black. Carbon black is available, for example, under the brand names, Super P® or Ketjenblack®.

When present, the conductive agent is different from the carbon-based material described above.

The amount of optional conductive agent is preferably from 0 to 30 wt % of the total solids in the electrode forming composition. In particular, for cathode forming compositions the optional conductive agent is typically from 0 wt % to 10 wt %, more preferably from 0 wt % to 5 wt % of the total amount of the solids within the composition.

For anode forming compositions which are free from silicon based electro active compounds the optional conductive agent is typically from 0 wt % to 5 wt %, more preferably from 0 wt % to 2 wt % of the total amount of the solids within the composition, while for anode forming compositions comprising silicon based electro active compounds it has been found to be beneficial to introduce a larger amount of optional conductive agent, typically from 0.5 to 30 wt % of the total amount of the solids within the composition.

In step ii) of the process of the present invention, mixing electrode active material (AM), the polymer (P) as above defined, and optionally, at least one conductive agent is performed by dry-blending these ingredients without the addition of any solvents, liquids, processing aids, or the like to the particle mixture. Dry-mixing may be carried out, for example, in a mill, mixer or blender (such as a V-blender equipped with a high intensity mixing bar, or other alternative equipment as described further below), until a uniform dry mixture is formed. Those skilled in the art will identify, after perusal of this document, that blending time can vary based on batch size, materials, particle size, densities, as well as other properties, and yet remain within the scope hereof.

In step iii) of the process of the invention, the powdered dry mixture obtained in step ii) is subjected to mechanical compaction step to provide a self-supporting dry film.

The compacting of the dry mixture obtained in step ii) can take place as a mechanical compaction, for example by means of a roller compactor or a tablet press, but it can also take place as rolling, build-up or by any other technique suitable for this purpose.

The mechanical compaction step may be associated to a thermal consolidation step. The combination of an applied pressure and a heat treatment makes thermal consolidation possible at lower temperatures than if it were done alone.

In one embodiment, the mechanical compaction step is carried out by compression, suitably by compressing the dry mixture obtained in step ii) between two metal foils. Preferably, the mechanical compaction step is done by application of a compression pressure between 5 and 50 MPa, and preferably between 10 and 30 MPa.

The compaction step is conveniently carried out at a temperature not exceeding 200° C., preferably at a temperature lower than 180° C.

In step iv), the dry film obtained in step iii) is applied onto an electrically conductive substrate to form the electrode.

The sheet of substrate material may comprise a metal foil, an aluminum foil in particular.

Thanks to the improved adhesion of the composition (C), the dry film obtained in step iii) can be applied onto the electrically conductive substrate without the need for any primer or adhesive layer.

Steps i) to iv) can be performed as a single step, or as separate steps; some of the steps may be separated and/or combined functionally during performance of some embodiments.

The polymer (P) could be conveniently used as the only binder in the preparation of electrodes according to the process of the present invention, or it can be used in blend with PTFE.

According to another aspect of the present invention, it is thus provided a process for manufacturing an electrode [electrode (E1)] for electrochemical cell, said process comprising:
step I) combining a polytetrafluoroethylene (PTFE) and a polymer (P) as above defined to provide a binder (B);
step II) dry mixing the at least one electrode active material (AM), the binder (B) as above defined, and optionally, at least one conductive agent in the absence of solvent to provide a dry electrode forming composition [composition (C1)];
step III) feeding the composition (C1) obtained in step II) to a compactor to form a self-supporting dry film; and
step IV) applying the dry film to an electrically conductive substrate to form the electrode.

In the context of the present invention, the term “PTFE” indicates a polymer obtained from the polymerization of tetrafluoroethylene (TFE).

It is understood, however, that the PTFE polymer may also comprise minor amounts of one or more co-monomers such as, but not limited to, hexafluoropropylene, perfluoro(methyl vinyl ether), perfluoro(propyl vinyl ether), perfluoro-(2,2-dimethyl-1,3-dioxole), and the like, provided, however that the latter do not significantly adversely affect the unique properties of the tetrafluoroethylene homopolymer, such as thermal and chemical stability. Preferably, the amount of such co-monomer does not exceed about 3% by moles, and more preferably less than about 1% by moles; particularly preferred is a co-monomer content of less than 0.5% by moles. In the case that the overall co-monomer content is greater than 0.5% by moles, it is preferred that the amount of the perfluoro(alkyl vinylether) co-monomer is less than about 0.5% by moles. Most preferred are PTFE homopolymers.

The PTFE suitable for use in the preparation of the binder (B) of the present invention is in the form of powder.

PTFE in the form of powder may be obtained by coagulating PTFE lattices by means of cryogenic coagulation or by electrolytic coagulation with the addition of an electrolyte. See, for example, U.S. Pat. No. 6,790,932. Preferred examples of electrolytes are:
Aluminum sulphate (Al₂(SO₄)₃), in concentration of 2 g/l calculated on amount of water in the coagulation vessel,
Ammonium carbonate ((NH₄)₂CO₃), in concentration of 8 g/l calculated on amount of water in the coagulation vessel, or
Nitric acid (HNO₃), 25 ml of a solution at 65% calculated on amount of water in the coagulation vessel.

Alternatively, the powder of PTFE may be obtained from PTFE lattices in the form of gels by means of coagulation with the electrolytes mentioned above. The gels may be obtained according to U.S. Pat. Nos. 6,790,932 and 6,780,966.

After the coagulation occurred, the polymer is washed at room temperature with demineralized water. After coagulation and washing, the PTFE powder obtained therein is then dried.

The PTFE in the form of powder generally has a particle size of between 1 and 1600 microns, preferably from 100 to 800 microns and more preferably 400-700 microns.

Generally the weight ratio PTFE/polymer (P) will be comprised between 95/5 wt/wt to 5/95 wt/wt. The skilled in the art will select most appropriate weight ratio in view of target final properties of the binder (B).

In particular, when binder (B) is used in the preparation of a negative electrode, the weight ratio PTFE/polymer (P) is conveniently comprised in the range 50/50 wt/wt to 5/95 wt/wt.

In one preferred embodiment, the weight ratio PTFE/polymer (P) in binder (B) for use in the preparation of a negative electrode is 20/80 wt/wt, which provides a negative electrode endowed with a surprisingly improved capacity.

The applicant has surprisingly found that an amount of polymer (P) added to PTFE does not affect the ability to fibrillate PTFE.

The amount of binder (B) which may be used in the composition (C1) is subject to various factors. One such factor is the surface area and amount of the active material, and the surface area and amount of any electroconductivity-imparting additive which are added to the electrode-forming composition. These factors are believed to be important because the binder particles provide bridges between the conductor particles and conductive material particles, keeping them in contact.

The composition (C1) includes one or more electrode active material (AM) as above defined.

Dry mixing step II) involves the fibrillization of the binder particles to produce fibrils that eventually form a matrix for supporting the resulting composition of matter. The resulting dough-like material may be calendared many times to produce a conductive film of desired thickness and density. The mixing can be provided by subjecting the mixture to an extruder.

The same details provided above with regard to steps i) to iv) apply respectively to steps I) to IV).

Steps I) to IV) can be performed as a single step, or as separate steps; some of the steps may be separated and/or combined functionally during performance of some embodiments.

The composition (C) or the composition (C1) obtained in step ii) or in step II) of the processes according to the present invention may further include at least one sulfide-based solid electrolyte.

When the composition (C) or the composition (C1) used in the processes according to the present invention includes at least one sulfide-based solid electrolyte or at least one garnet-type inorganic particle based solid electrolyte, the present invention provides electrodes suitable for use in solid-state batteries obtainable by the processes as above defined [electrode (ESS)].

Thus, in one embodiment, the present invention provides a process for manufacturing an electrode for solid-state batteries [electrode (ESS)], said process comprising:
a) providing a polymer (P) as above defined;
b) dry mixing at least one electrode active material (AM), the polymer (P) provided in step i) as above defined, at least one sulfide-based solid electrolyte or at least one garnet-type inorganic particle based solid electrolyte and, optionally, at least one conductive agent in the absence of solvent to provide a dry electrode forming composition [composition (C′)];
c) feeding the composition (C′) obtained in step ii) to a compactor to form a self-supporting dry film; and
d) applying the dry film to an electrically conductive substrate to form the electrode.

The same details provided above with regard to steps i) to iv) apply respectively to steps a) to d).

In another embodiment the present invention provides a process for manufacturing an electrode for solid-state batteries [electrode (ESS-1)], said process comprising:
step I′) combining a polytetrafluoroethylene (PTFE) and a polymer (P) as above defined to provide a binder (B);
step II′) dry mixing the at least one electrode active material (AM), the binder (B) as above defined, at least one sulfide-based solid electrolyte and, and optionally, at least one conductive agent in the absence of solvent to provide a dry electrode forming composition [composition (C1′)];
step III′) feeding the composition (C1′) obtained in step ii) to a compactor to form a self-supporting dry film; and
step IV′) applying the dry film to an electrically conductive substrate to form the electrode.

The same details provided above with regard to steps i) to iv) apply respectively to steps I′) to IV′).

As used here, the phrase “sulfide-based solid electrolyte,” refers to an inorganic solid state material that conducts Li⁺ ions but is substantially electronically insulating.

In the present invention, the term “sulfide-based solid ionic conducting inorganic particle” is not particularly limited as long as it is a solid electrolyte material containing sulfur atom(s) in the molecular structure or in the composition.

The sulfide-based solid ionic conducting inorganic particle preferably contains Li, S, and an element of from 13 to 15 groups, for instance, P, Si, Sn, Ge, Al, As, Sb, or B, to increase Li-ion conductivity.

The sulfide-based solid ionic conducting inorganic particle according to the present invention is preferably selected from the group consisting of:
lithium tin phosphorus sulfide (“LSPS”) materials, such as Li₁₀SnP₂S₁₂;
lithium phosphorus sulfide (“LPS”) materials, such as glass, crystalline or glass-ceramic of those of formula (Li₂S)ₓ—(P₂S₅)_{y}, wherein x+y=1 and 0≤x≤1, Li₇P₃S₁₁, Li₇PS₆, Li₄P₂S₆, Li_{9.6}P₃S₁₂ and Li₃PS₄;
doped LPS, such as Li₂CuPS₄, Li₁₊₂ₓZn₁₋ₓPS₄, wherein 0≤x≤1, Li_{3.33}Mg_{0.33}P₂S₆, and Li₄₋₃ₓScₓP₂S₆, wherein 0≤x≤1;
lithium phosphorus sulfide oxygen (“LPSO”) materials of formula LiₓP_{y}S_{z}O_{w}, wherein 0.33≤x≤0.67, 0.07≤y≤0.2, 0.4≤z≤0.55;
lithium phosphorus sulfide materials including X (“LXPS”), wherein X is Si, Ge, Sn, As, or Al, such as Li₁₀SnP₂S₁₂, Li₁₀GeP₂S₁₂, Li₁₀SiP₂S₁₂, and Li₂S—P₂S₅—SnS;
lithium phosphorus sulfide oxygen including X (“LXPSO”), wherein X is Si, Ge, Sn, As, or Al;
lithium silicon sulfide (“LSS”) materials, such as Li₂SiS₃, Li₂S—P₂S₅—SiS₂, Li₂S—P₂S₅-SiS₂—LiCl, Li₂S—SiS₂—P₂S₅, Li₂S—SiS₂—P₂S₅—LiI, Li₂S—SiS₂—LiI, Li₂S—SiS₂, Li_{9.54}Si_{1.74}P_{1.44}S_{11.7}Cl_{0.3}, and Li₂S—SiS₂—Al₂S₃;
lithium boron sulfide materials, such as Li₃BS₃ and Li₂S—B₂S₃—LiI;
lithium tin sulfide materials and lithium arsenide materials, such as Li_{0.8}Sn_{0.8}S₂, Li₄SnS₄, Li_{3.833}Sn_{0.833}As_{0.166}S₄, Li₃AsS₄—Li₄SnS₄, and Ge-substituted Li₃AsS₄;
lithium phosphorus sulfide materials of general formula LiₐPS_{b}X_{c}, wherein X represents at least one halogen element selected from the group consisting of Cl, Br and I or a combination thereof; and a represents a number from 2.0 to 7.0, b represents a number from 3.5 to 6.0, and c represents a number from 0 to 3.0, such as Li₄PS₄Cl, Li₇P₂S₈Cl, and Li₇P₂S₈I.

In a more preferred embodiment, the sulfide-based solid ionic conducting inorganic particle is a lithium phosphorus sulfide material of the above general formula LiₐPS_{b}X_{c}, more particularly Argyrodite-type sulfide material of formula Li₆PS₅X, wherein X is Cl, Br or I.

In another preferred embodiment, the Argyrodite-type sulfide material of formula Li₆PS₅Y is deficient in sulfur and/or lithium, for instance Li₆₋ₓPS₅₋ₓCl₁₊ₓ with 0≤x≤0.5, or doped with a heteroatom.

Particularly preferred sulfide solid electrolytes are LPS materials, LSPS materials and Argyrodite-type sulfide materials.

Electrode (E), electrode (E1) and electrode (ESS) of the present invention are particularly suitable for use in electrochemical devices, in particular in secondary batteries.

In one aspect, the present invention provides an electrochemical device being a secondary battery comprising:
a positive electrode and a negative electrode,
wherein at least one of the positive electrode and the negative electrode is an electrode (E), (E1) or (ESS) according to the present invention.

In a further object, the present invention provides a solid state battery comprising a composite solid electrolyte film, a positive electrode and a negative electrode,
wherein at least one of the negative electrode or the positive electrode is an electrode (ESS) according to the invention.

The secondary battery of the invention is preferably an alkaline or an alkaline-earth secondary battery.

The secondary battery of the invention is more preferably a lithium-ion secondary battery.

An electrochemical device according to the present invention can be prepared by standard methods known to a person skilled in the art.

Should the disclosure of any patents, patent applications, and publications which are incorporated herein by reference conflict with the description of the present application to the extent that it may render a term unclear, the present description shall take precedence.

The invention will be now described with reference to the following examples, whose purpose is merely illustrative and not intended to limit scope of the invention.

### EXAMPLES

### Materials and Methods

Silicon oxide, KSC-1064 commercially available from Shin-Etsu, theoretical capacity is about 2100 mAh/g;

Graphite, GHDR 15-4 commercially available from Imerys S.A.;

Carbon black, commercially available as SC45 from Imerys S.A.;

Carbon black, commercially available as SC65 available from Imerys S.A.;

PTFE: PTFE homopolymer powder having specific gravity, measured according to ASTM D792, of 2160 and having rheometric pressure, measured according to ASTM D4895, of 9.50 MPa;

Lithium Iron Phosphate, LFP, available as Life Power from Johnson Matthey;

Galden HT80 commercially available from Solvay Materials;

A: Acrylic Acid available from Aldrich;

AM: Acrylamide monomer (50% water solution) available from SNF;

VIm: vinylimidazole monomer available from Aldrich.

### Synthesis of Terpolymer of AA-AM-Vim (Polymer P1)

The synthesis process was conducted in a thermally isolated reactor to minimize the heat exchange with surrounding (Thermos like flask).

The reactor was equipped with a lid containing multiple entries into which were installed a small reflux system, a mechanical stirring system, a nitrogen purge line and a raw materials feed line.

In a first step, all monomers (117.8 g AA, 478.5 g AM, 18 g Vim), solvent (water 871.6 g) and a transfer agent, were charged into the reactor and kept under stirring and nitrogen purging for around 1 hour at room temperature. Then, the redox type initiator was added to the reaction mixture. The thermal initiator was also added at same time into the reaction mixture. The initiator was homogenized in the reaction mixture for a few minutes with mechanical stirring, then the stirring and nitrogen purge were stopped.

An increase of the reaction mixture temperature from room temperature up to around 80-90° C. was obtained within around half to one hour time as an exothermic effect. Then, the reaction mixture was maintained in the reaction flask for further 24 hours.

The polymer obtained has a Mw of 1400 kDa measured by GPC.

### Powder Preparation of Polymer P1:

Powder of polymer P1 obtained as above detailed was prepared by drying in an oven a polymer solution followed by grinding in a mortar grinder from Retsch model RM200 according to the following procedure.

50 g of aqueous solution of polymer P1 (polymer content 7%) was dried in an oven for 12 hours at 70° C. to eliminate the water. The polymer lumps obtained were then grinded into fine powder by using an automatic mortar for a total time of 20 minutes.

### Polymer Mixing:

The powder of polymer P1 and PTFE were manually mixed in the powder form in a ratio of 1:1 and 4:1.

### Film Preparation

7 g of powder mixture of polymer P1 and PTFE was grinded in automatic stainless steel mortar for 8 minute with the addition of 5 mL of Galden as lubricant. Such obtained prefilm was manipulated manually in order to fibrillate the polymer and obtain gross and cohese self-standing film. Film was calendered to lower the thickness below 200 μm.

Lamination with Metal Substrate:

The film obtained as above detailed was placed between two aluminum foils and preheated at 150° C. for 10 minutes in a press. Then 160 Bars was applied for 10 minutes to laminate film to aluminum foil at a temperature of 150° C. and at a pressure of 160 Bars. Press was then cooled down to room temperature without releasing the pressure.

The same procedure was carried out using two copper foils instead of aluminum foils.

### Adhesion Assessment and Measure

Adhesion assessment and measurements were carried out between the laminated sample as above specified and foil by following ASTM D 1876 on the 3 layer structure obtained after the lamination (metal foil/film/metal foil). The adhesion levels are reported in Table 1. No adhesion was observed with PTFE powders when employed alone in the preparation of films by compression between two aluminum foils nor between two copper foils.

The peel strength was evaluated based on the following criteria. A larger value for the peel strength indicates better close adherence between the polymer and the current collector
A: Peel strength of at least 5.0 N/m
B: Peel strength of at least 0.1 N/m and less than 5.0 N/m
C: Adhesion obtained, difficult to measure due to rigidity of specimen
D: No adhesion

TABLE 1

| | Adhesion level | Adhesion level |
|---|---|---|
| | to Al | to Cu |
| Polymer P1 | C | C |
| Polymer P1-PTFE | A | B |
| mixture ratio 1:1 | | |
| PTFE | D | D |

### Example 1: LFP Electrode Preparation Composition of Polymer (P1) and PTFE

A dry mixture of 6.48 g of LFP and 0.36 g of SC65 was prepared by grinding for 10 minutes the powders in an electric mortar.

4 ml of Galden as lubricant was added to the powder mixture and the composite mixed in electric mortar for 1 minute. A homogeneous paste was obtained.

0.18 g of polymer P1 powder, 0.18 g of PTFE with 3 ml of Galden as lubricant were added to the homogeneous paste and mixed in a mortar grinder for 5 min. A homogeneous composite was obtained.

The composite was then manipulated manually in order to fibrillate the polymer and obtain gross and cohese self-standing film.

Film was calendered to lower the thickness below 200 μm.

The resulting positive electrode had the following composition: 90 wt % of LFP, 2.5 wt % of polymer P1, 2.5% PTFE and 5 wt % of carbon black.

Electrode EC1 was thus obtained.

The EC1 sample was placed between two aluminum current collectors and preheated at 150° C. for 10 minutes in a press. Then 160 Bars was applied for 10 minutes to laminate EC1 to current collector at a temperature of 150° C. and at a pressure of 160 Bars. Press was then cooled down to room temperature without releasing the pressure.

Electrode laminated on Al current collector is obtained.

### Example 2: Graphite/Silicon Electrode Preparation Composition 1:1 of Polymer P1 and PTFE

A dry mixture of 5.41 g of graphite, 1.36 g of silicon and 0.072 g of SC45 was prepared by grinding for 10 minutes the powders in an electric mortar.

5 ml of Galden as lubricant was added to the powder mixture and the composite mixed in electric mortar for 1 minute. A homogeneous paste was obtained.

0.18 g of polymer P1 powder, 0.18 g of PTFE with 4 ml of Galden as lubricant were added to the homogeneous paste and mixed in a mortar grinder for 5 min. A homogeneous composite was obtained.

The composite was then manipulated manually in order to fibrillate the polymer and obtain gross and cohese self-standing film.

Film was calendered to lower the thickness below 200 μm.

The resulting negative electrode had the following composition: 75.2 wt % of graphite, 18.8 wt % of silicon, 2.5 wt % of polymer P1, 2.5% PTFE and 1 wt % of carbon black.

Electrode EC2 was thus obtained.

The EC2 sample was placed between two copper current collectors and preheated at 150° C. for 10 minutes in a press. Then 160 Bars was applied for 10 minutes to laminate EC2 to current collector at a temperature of 150° C. and at a pressure of 160 Bars. Press was then cooled down to room temperature without releasing the pressure.

Electrode laminated on Cu current collector is obtained.

### Example 3: Graphite/Silicon Electrode Preparation Composition of Polymer P1

A dry mixture of 3.82 g of graphite, 0.95 g of silicon and 0.050 g of SC45 was prepared by grinding for 10 minutes the powders in an electric mortar.

2.38 g of polymer P1 powder were added to the powders and mixed in a mortar grinder for 5 min to get a homogeneous distribution.

The powder was spreaded between two copper current collectors and preheated at 150° C. for 10 minutes in a press. Then 160 Bars was applied for 10 minutes to laminate EC3 to current collector at a temperature of 150° C. and at a pressure of 160 Bars. Press was then cooled down to room temperature without releasing the pressure.

Electrode laminated on Cu current collector is obtained.

The resulting negative electrode had the following composition: 53 wt % of graphite, 13.3 wt % of silicon, 33 wt % of polymer P1 and 0.71 wt % of carbon black.

Sample EC3 was thus obtained.

### Example 4: Graphite/Silicon Electrode Preparation Composition 4:1 of Polymer P1 and PTFE

A dry mixture of 5.41 g of graphite, 1.36 g of silicon and 0.072 g of SC45 was prepared by grinding for 10 minutes the powders in an electric mortar.
5 ml of Galden was added to the powder mixture and the composite mixed in electric mortar for 1 minute. A homogeneous paste was obtained.

0.288 g of polymer (A) powder, 0.072 g of PTFE with 4 ml of Galden were added to the homogeneous paste and mixed in a mortar grinder for 5 min.

A homogeneous composite was obtained.

The composite was then manipulated manually in order to fibrillate the polymer and obtain gross and cohese self-standing film.

Film was calendered to lower the thickness below 200 μm.

The resulting negative electrode had the following composition: 75.2 wt. % of graphite, 18.8 wt. % of silicon, 2.5 wt. % of polymer (A), 2.5% PTFE and 1 wt. % of carbon black.

Electrode EC4 was thus obtained.

The EC4 sample was placed between two copper current collectors and preheated at 150° C. for 10 minutes in a press. Then 160 Bars was applied for 10 minutes to laminate EC4 to current collector at a temperature of 150° C. and at a pressure of 160 Bars. Press was then cooled down to room temperature without releasing the pressure.”

### Comparative Example 1: LFP Electrode Preparation with PTFE

A dry mixture of 6.48 g of LFP and 0.36 g of SC65 was prepared by grinding for 10 minutes the powders in an electric mortar.

4 ml of Galden as lubricant was added to the powder mixture and the composite mixed in electric mortar for 1 minute. A homogeneous paste was obtained.

0.36 g of PTFE with 3 ml of Galden as lubricant were added to the homogeneous paste and mixed in a mortar grinder for 5 min. A homogeneous composite was obtained.

The composite was then manipulated manually in order to fibrillate the polymer and obtain gross and cohese self-standing film.

Film was calendered to lower the thickness below 200 μm.

The resulting positive electrode had the following composition: 90 wt % of LFP, 5% PTFE and 5 wt % of carbon black.

Electrode CE1 was thus obtained.

The CE1 sample was placed between two aluminum current collectors and preheated at 150° C. for 10 minutes in a press. Then 160 Bars was applied for 10 minutes to laminate CE1 to current collector at a temperature of 150° C. and at a pressure of 160 Bars. Press was then cooled down to room temperature without releasing the pressure.

No lamination of electrode with aluminum is obtained.

### Comparative Example 2: Graphite/Silicon Electrode Preparation with PTFE

A dry mixture of 5.41 g of graphite, 1.36 g of silicon and 0.072 g of SC45 was prepared by grinding for 10 minutes the powders in an electric mortar.

5 ml of Galden as lubricant was added to the powder mixture and the composite mixed in electric mortar for 1 minute. A homogeneous paste was obtained.

0.36 g of PTFE with 4 ml of Galden as lubricant were added to the homogeneous paste and mixed in a mortar grinder for 5 min. A homogeneous composite was obtained.

The composite was then manipulated manually in order to fibrillate the polymer and obtain gross and cohese self-standing film.

Film was calendered to lower the thickness below 200 μm.

The resulting negative electrode had the following composition: 75.2 wt % of graphite, 18.8 wt % of silicon, 5% PTFE and 1 wt % of carbon black.

Electrode CE2 was thus obtained.

The CE2 sample was placed between two copper current collectors and preheated at 150° C. for 10 minutes in a press. Then 160 Bars was applied for 10 minutes to laminate CE2 to current collector at a temperature of 150° C. and at a pressure of 160 Bars. Press was then cooled down to room temperature without releasing the pressure.

No lamination of electrode with copper is obtained.

### Adhesion of Electrode Composition to Current Collector: Assessment and Measure

Adhesion assessment and measurements were carried out between the electrode compositions obtained as above specified and the copper or aluminum foil by following ASTM D 1876 on the 3 layer structure obtained after the lamination (metal foil/film/metal foil). The adhesion values are reported in Table 2. No adhesion was observed for CE1 and CE2.

The peel strength was evaluated based on the following criteria. A larger value for the peel strength indicates better close adherence between the negative electrode mixed material layer and the current collector.
A: Peel strength of at least 2.0 N/m
B: Peel strength of at least 0.1 N/m and less than 2.0 N/m
C: Adhesion obtained, difficult to measure due to rigidity of specimen
D: No adhesion

TABLE 2

| | Adhesion level |
|---|---|
| EC1 | A |
| EC2 | A |
| EC3 | C |
| CE1 | D |
| CE2 | D |

### Electrical Resistance Measurement

The electrical resistance of EC1, EC2, CE1 and CE2 was measured with a Keithley Multimeter. 20 mm diameter disk obtained from the samples were pressed between two 10 mm diameter electrodes connected to the Keithley with a dinamometer applying 50N for 1 min and then the resistance was recorded. The mean resistances of the 2 samples, calculated as mean value of measures repeated in triple, are reported in Table 3 below. Values are similar for both compositions

TABLE 3

| | Resistance (Ω) |
|---|---|
| EC1 | 3.2 |
| CE1 | 3.2 |
| EC2 | 0.2 |
| CE2 | 0.2 |

The data show that the binders of the present invention have improved adhesion to current collectors, while at the same time they keep good electric conductivity properties, so that they can be suitably used as binders for electrodes.

### Cyclic Voltammetry Evaluation

Cyclic voltammetry was performed on EC2 and EC4 sample to evaluate different ratio of binder. Test was performed in coin cell in Lithium versus negative electrode setup between 3 and 0.01 V with a scan rate of 10 mV/s. 1M LiPF6 in EC:DMC 1:1 vol/vol was used as electrolyte. Table 4 contains data on first cycle's peak position and height:

TABLE 4

| | Peak | Peak |
|---|---|---|
| | height | position |
| Cycle | (mA) | (V) |
| EC2 | 1.34 | 0.32 |
| EC4 | 1.56 | 0.32 |

Results indicate that reducing PTFE content maintain very good electrochemical behaviour: peak position is not altered and current extracted is not reduced.

1. A process for manufacturing an electrode [electrode (E)] for an electrochemical cell, said process comprising the following steps:
i) providing a polymer (P) that comprises:
(A) recurring units derived from at least one α,β-ethylenically unsaturated carboxylic acid monomer [monomer (AA)]; and
(B) recurring units derived from at least one (meth)acrylamide monomer [monomer (AM)] of formula (I): 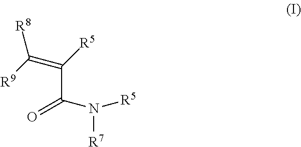
wherein:
R⁵ represents a hydrogen atom or a methyl group, R⁶ and R⁷, being the same or different from each other, are selected from the group of a hydrogen atom, and a linear or a branched alkyl group having 1 to 6 carbon atoms, R⁸ and R⁹, being the same or different from each other, are selected from the group consisting of a hydrogen atom, a linear or a branched alkyl group having 1 to 6 carbon atoms, a carboxylic group and an amide group;
(C) optionally, recurring units derived from at least one monomer (M) selected from the group consisting of a monomer (M1) and a monomer (M2), wherein
the monomer (M1) is an ethylenically unsaturated monomer carrying an unsaturated heterocyclic group having at least one nitrogen atom, said monomer (M1) having the formula (II) below: 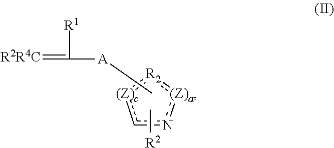
wherein:
R¹ is H or an alkyl group;
R² is H or an alkyl group;
R³ and R⁴, being the same or different from each other, are selected from the group of a hydrogen atom, and a linear or a branched alkyl group having 1 to 6 carbon atoms;
A is a linkage selected from the group consisting of:
a single covalent bond; and
a spacer;
wherein X, Y and Z, independently from each other, are selected from a carbon atom or a nitrogen atom;
wherein a, b and c are, independently from each other, selected from the integer 1 to 2;
wherein each dashed-dotted line represents an optional double bond;
the monomer (M2), different from monomer the (AA) and from the monomer (AM), said monomer (M2) having the formula (III) below: 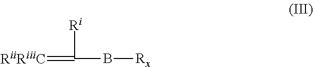
wherein:
Rⁱ is selected from the group consisting of H, —COOH, —CH₂COOH and an alkyl group;
Rⁱⁱ and Rⁱⁱⁱ, being the same or different from each other, are selected from the group of a hydrogen atom, a linear or a branched alkyl group having 1 to 6 carbon atoms, and a —COOH group;
B is a linkage selected from the group consisting of a —C(O)—O— group and a —C(O)—NH— group;
Rₓ is selected from the group of a hydrogen atom, and a linear or a branched C₃-C₂₀ hydrocarbon chain moiety comprising at least one functional group selected from the group consisting of ether (—O—), heterocyclic group, sulfonic acid group (—SO₃H), salt of sulfonic acid group (—SO₃Cat), phosphonic acid group (—PO₃H₂), salt of phosphonic acid group (—PO₃Cat₂), phosphoric acid group (—OPO₃H₂), and salt of a phosphoric acid group (—OPO₃Cat₂), with Cat being a monovalent cation;
ii) dry mixing at least one electrode active material (AM), the polymer (P) provided in step i) and optionally, at least one conductive agent in the absence of a solvent to provide a dry electrode forming composition [composition (C)];
iii) feeding the composition (C) obtained in step ii) to a compactor to form a self-supporting dry film; and
iv) applying the dry film to an electrically conductive substrate to form the electrode.

2. The process according to claim 1, wherein the monomer (AA) is a compound of formula (IV): 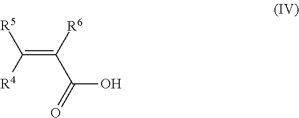
wherein R⁴, R⁵ and R⁶, equal to or different from each other, are independently selected from the group of a hydrogen atom and a C₁-C₃ hydrocarbon group.

3. The process according to claim 1, wherein the monomer (AM) of formula (I) is selected from the group consisting of (meth)acrylamides or N-substituted (meth)acrylamide.

4. The process according to claim 1, wherein the monomer (M1) is selected from the group consisting of:
vinylimidazole (VIm) of formula (IIa): 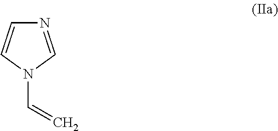
2-methyl-1-vinylimidazole of formula (IIb) 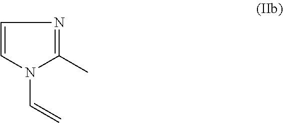
1-vinyl-1,2,4-triazole of formula (IIc) 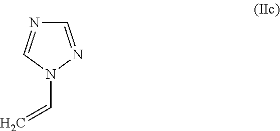
2-vinylpyrazine of formula (IId) 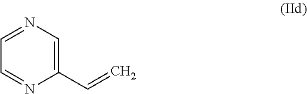
4-vinylpyridine of formula (IIe) 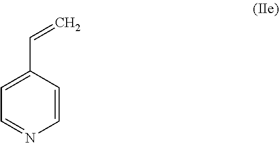
2-vinylpyridine of formula (IIf) 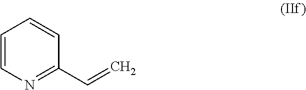
hydroxyl-(meth)acrylate imidazole derivative of formula (IIg)

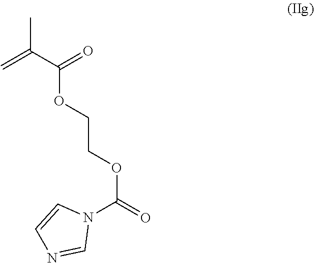 [SMILES: C=C(C)C(=O)OCCOC(=O)n1ccnc1]

5. The process according to claim 1, wherein the polymer (P) comprises:
from 0.1 to 95% of recurring units derived from the monomer (AA),
from 0.1 to 90% of recurring units derived from the monomer (AM), and
from 1 to 50% of recurring units derived from the monomer (M),
wherein at least one of the monomer (AA) and the monomer (AM) is not in an amount of 0%,
all the aforementioned % by moles being referred to the total moles of recurring units of the polymer (P).

6. The process according to claim 1, wherein the composition (C) further comprises one or more electroconductivity-imparting additives.

7. An electrode (E) for a secondary battery obtained by the process according to claim 1.

8. A process for manufacturing an electrode [electrode (E1)] for an electrochemical cell, said process comprising the following steps:
step I) combining a polytetrafluoroethylene (PTFE) and a polymer (P) that comprises:
(A) recurring units derived from at least one α,β-ethylenically unsaturated carboxylic acid monomer [monomer (AA)]; and
(B) recurring units derived from at least one (meth)acrylamide monomer [monomer (AM)] of formula (I): 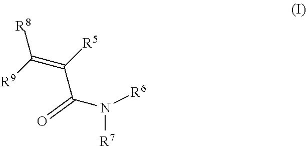
wherein:
R⁵ represents a hydrogen atom or a methyl group, R⁶ and R⁷, being the same or different from each other, are selected from the group of a hydrogen atom and a linear or a branched alkyl group having 1 to 6 carbon atoms, R⁸ and R⁹, being the same or different from each other, are selected from the group consisting of a hydrogen atom, a linear or a branched alkyl group having 1 to 6 carbon atoms, a carboxylic group and an amide group;
(C) optionally, recurring units derived from at least one monomer (M) selected from the group consisting of a monomer (M1) and a monomer (M2), wherein:
the monomer (M1) is an ethylenically unsaturated monomer carrying an unsaturated heterocyclic group having at least one nitrogen atom, said monomer (M1) having the formula (II) below: 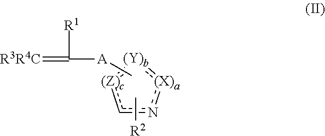
wherein:
R¹ is H or an alkyl group;
R² is H or an alkyl group;
R³ and R⁴, being the same or different from each other, are selected from the group of a hydrogen atom and a linear or a branched alkyl group having 1 to 6 carbon atoms;
A is a linkage selected from the group consisting of:
a single covalent bond; and
a spacer;
wherein X, Y and Z, independently from each other, are selected from a carbon atom or a nitrogen atom;
wherein a, b and c are, independently from each other, selected from the integer 1 to 2;
wherein each dashed-dotted line represents an optional double bond;
the monomer (M2), different from the monomer (AA) and from the monomer (AM), said monomer (M2) having the formula (II) below: 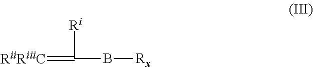
wherein:
Rⁱ is selected from the group consisting of H, —COOH, —CH₂COOH and an alkyl group;
Rⁱⁱ and Rⁱⁱⁱ, being the same or different from each other, are selected from the group of a hydrogen atom, a linear or a branched alkyl group having 1 to 6 carbon atoms, and a —COOH group;
B is a linkage selected from the group consisting of a —C(O)—O— group and a —C(O)—NH— group;
Rₓ is selected from the group of a hydrogen atom and a linear or a branched C₃-C₂₀ hydrocarbon chain moiety comprising at least one functional group selected from the group consisting of ether (—O—), heterocyclic group, sulfonic acid group (—SO₃H), salt of sulfonic acid group (—SO₃Cat), phosphonic acid group (—PO₃H₂), salt of phosphonic acid group (—PO₃Cat₂), phosphoric acid group (—OPO₃H₂), and salt of a phosphoric acid group (—OPO₃Cat₂), with Cat being a monovalent cation;
to provide a binder (B);
step II) dry mixing the at least one electrode active material (AM), the binder (B) and optionally, at least one conductive agent in the absence of a solvent to provide a dry electrode forming composition [composition (C1)];
step III) feeding the composition (C1) obtained in step ii) to a compactor to form a self-supporting dry film; and
step IV) applying the dry film to an electrically conductive substrate to form the electrode.

9. The process according to claim 8, wherein the weight ratio PTFE/polymer (P) in composition (C1) is comprised between 95/5 wt/wt to 5/95 wt/wt.

10. An electrode (E1) for a secondary battery obtained by the process according to claim 8.

11. A process for manufacturing an electrode for solid-state batteries [electrode (ESS)], said process comprising the following steps:
a) providing a polymer (P) that comprises:
(A) recurring units derived from at least one α,β-ethylenically unsaturated carboxylic acid monomer [monomer (AA)]; and
(B) recurring units derived from at least one (meth)acrylamide monomer [monomer (AM)] of formula (I): 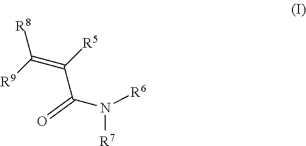
wherein:
R⁵ represents a hydrogen atom or a methyl group, R⁶ and R⁷, being the same or different from each other, are selected from the group of a hydrogen atom and a linear or a branched alkyl group having 1 to 6 carbon atoms, R⁸ and R⁹, being the same or different from each other, are selected from the group consisting of a hydrogen atom, a linear or a branched alkyl group having 1 to 6 carbon atoms, a carboxylic group and an amide group;
(C) optionally, recurring units derived from at least one monomer (M) selected from the group consisting of a monomer (M1) and a monomer (M2), wherein:
the monomer (M1) is an ethylenically unsaturated monomer carrying an unsaturated heterocyclic group having at least one nitrogen atom, said monomer (M1) having the formula (II) below: 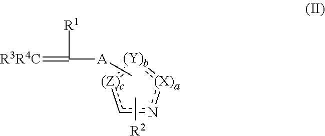
wherein:
R¹ is H or an alkyl group;
R² is H or an alkyl group;
R³ and R⁴, being the same or different from each other, are selected from the group of a hydrogen atom, and a linear or a branched alkyl group having 1 to 6 carbon atoms;
A is a linkage selected from the group consisting of:
a single covalent bond; and
a spacer;
wherein X, Y and Z, independently from each other, are selected from a carbon atom or a nitrogen atom;
wherein a, b and c are, independently from each other, selected from the integer 1 to 2;
wherein each dashed-dotted line represents an optional double bond;
the monomer (M2), different from the monomer (AA) and from the monomer (AM), said monomer (M2) having the formula (III) below: 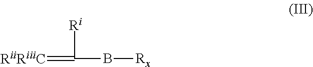
wherein:
Rⁱ is selected from the group consisting of H, —COOH, —CH₂COOH and an alkyl group;
Rⁱⁱ and Rⁱⁱⁱ, being the same or different from each other, are selected from the group of a hydrogen atom, a linear or a branched alkyl group having 1 to 6 carbon atoms, and a —COOH group;
B is a linkage selected from the group consisting of a —C(O)—O— group and a —C(O)—NH— group;
Rₓ is selected from the group of a hydrogen atom er and a linear or branched C₃-C₂₀ hydrocarbon chain moiety comprising at least one functional group selected from the group consisting of ether (—O—), heterocyclic group, sulfonic acid group (—SO₃H), salt of sulfonic acid group (—SO₃Cat), phosphonic acid group (—PO₃H₂), salt of phosphonic acid group (—PO₃Cat₂), phosphoric acid group (—OPO₃H₂), and salt of a phosphoric acid group (—OPO₃Cat₂), with Cat being a monovalent cation;
b) dry mixing at least one electrode active material (AM), the polymer (P) provided in step i), at least one sulfide-based solid electrolyte or at least one garnet-type inorganic particle based solid electrolyte and, optionally, at least one conductive agent in the absence of a solvent to provide a dry electrode forming composition [composition (C′)];
c) feeding the composition (C′) obtained in step b) to a compactor to form a self-supporting dry film; and
d) applying the dry film to an electrically conductive substrate to form the electrode.

12. An electrode (ESS) for a secondary battery obtained by the process according to claim 11.

13. The process according to claim 1, wherein the polymer (P) is in its neutralized form (P—N).

14. An electrochemical device, wherein at least one of positive electrode or negative electrode is the electrode (E) according to claim 7.

15. The process according to claim 1, wherein the active material (AM) comprises materials selected from the group consisting of one or more carbon-based materials and one or more silicon-based materials.

16. The process according to claim 1, wherein the active material (AM) is a phosphate-based electro-active material of formula Li(FeₓMn₁₋ₓ)PO₄ wherein 0≤x≤1.

17. The process according to claim 1, wherein R¹ is a methyl group.

18. The process according to claim 3, wherein the monomer (AM) of formula (I) is selected from the group of N-alkyl acrylamides and N,N-dialkylacrylamides.

19. An electrochemical device, wherein at least one of positive electrode or negative electrode is the electrode (E1) according to claim 1.

20. The process of claim 16, wherein the active material (AM) is selected from the group of lithium iron phosphate (LFP), lithium iron manganese phosphate (LMFP) and lithium manganese phosphate.
